(19) United States
(12) Patent Application Publication
(10) Pub. No.: US 2021/0400574 A1
(43) Pub. Date: Dec. 23, 2021

(54) CONTROL PLANE AND USER PLANE SELECTION FOR SMALL DATA

(71) Applicant: CONVIDA WIRELESS, LLC, Wilmington, DE (US)

(72) Inventors: Michael F. STARSINIC, Newtown, PA (US); Dale N. SEED, Allentown, PA (US); Hongkun LI, Malvern, PA (US); Catlina Mihaela MLADIN, Hatboro, PA (US); Rocco DI GIROLAMO, Laval (CA)

(21) Appl. No.: 17/293,063

(22) PCT Filed: Nov. 15, 2019
(86) PCT No.: PCT/US2019/061641

§ 371 Date: May 12, 2021

Related U.S. Application Data
(60) Provisional application No. 62/768,213, filed on Nov. 16, 2018.

(51) Int. Cl. H04W 48/18; H04W 76/25; H04W 4/14

(52) U.S. Cl. CPC H04W 48/18; H04W 84/042; H04W 4/14; H04W 76/25

(57) ABSTRACT

User equipment may be provisioned with information used to determine whether to send data via a user plane or a control plane. The information may be a management object comprising rules or polices, or uplink rate control information, for example. The user equipment may then respond to conditions autonomously, e.g., in response to congestion. An application or a service layer on user equipment may receive control plane/user plane (CPUP) selection policies. The application or service layer may then apply the CPUP selection policies to uplink traffic in determining whether uplink traffic should be sent over the user plane or control plane.

### CROSS-REFERENCE TO RELATED APPLICATION

This application claims the benefit of U.S. Provisional Application No. 62/768,213, filed Nov. 16, 2018, titled “Control Plane and User Plane Selection For Small Data,” the content of which is hereby incorporated by reference in its entirety.

### BACKGROUND

This disclosure pertains to the management of user data in Internet-of-Things (IoT), machine-to-machine (M2M), and Web-of-Things (WoT) environments, including environments described in, for example, oneM2M TS 23.682 Architecture enhancements to facilitate communications with packet data networks and applications; oneM2M TS 23.401 General Packet Radio Service (GPRS) enhancements for Evolved Universal Terrestrial Radio Access Network (E-UTRAN) access; and oneM2M TR 23.724 Study on Cellular IoT support and evolution for the 5G System.

### SUMMARY

A user equipment (UE) may be provisioned with policies or rules that may be used to determine whether data should be sent via the user plane or via the control plane. For example, a UE may receive a management object (MO) via NAS or SMS signaling which provides such policies or rules. Additionally, or alternatively, a UE may receive APN Uplink Rate Control information for the control plane and user plane in the PCO when a PDN connection/PDU Session is established, for example.

A UE may then respond to conditions autonomously. For example, if the UE then receives an indication that the control plane is congested, based on the indication the UE may move one or more PDN connections and PDU sessions from the control plane to the user plane, or use the user plane for new PDN connections and PDU sessions. When the congestion indication is removed, the UE may move its PDN connection and PDU sessions from the user plane to the control plane or use the control plane for new PDN connections/PDU sessions.

An application or a service layer on a UE may receive CPUP selection policies and apply the CPUP selection policies to UL traffic by using the policies to determine if UL traffic should be sent over the user plane or control plane.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

A more detailed understanding may be had from the following description, given by way of example in conjunction with the accompanying drawings.

FIG. 1 illustrates an example architecture for small data delivery.

FIG. 2 illustrates an example 5G non-roaming architecture reference model.

FIG. 3 shows an example overall message flow for control plane/user plane enhancements in a 4G system.

FIG. 4 shows an example overall message flow for control plane/user plane enhancements in a 5G system.

FIG. 5 is a system diagram of an example machine-to-machine (M2M), Internet of Things (IoT), or Web of Things (WoT) communication system in which one or more disclosed embodiments may be implemented.

FIG. 6 is a system diagram of an example architecture that may be used within the M2M/IoT/WoT communications system illustrated in FIG. 5.

FIG. 7 is a system diagram of an example communication network node, such as an M2M/IoT/WoT device, gateway, or server that may be used within the communications system illustrated in FIGS. 5 and 6.

FIG. 8 is a block diagram of an example computing system in which a node of the communication system of FIG. 5 and may be embodied.

### DETAILED DESCRIPTION

Table 1 of the Appendix describes several abbreviations used herein.

Herein, the terms “user plane” and “data plane” are often used interchangeably.

Herein, the terms “control plane” and “signaling plane” are often used interchangeably.

Herein, the term “PDN connection” generally refers to a packet data connection between a UE and P-GW or SCEF in a 4G network.

Herein, the term “PDU session” generally refers to a packet data session between a UE and a UPF or NEF in a 5G network.

Herein, the terms “PDN connection” and “PDU session” are often used interchangeably. It will be appreciated that the techniques described herein may be applied equally to a PDN connection and a PDU session.

Here, the control plane congestion is used as a trigger to have a UE change from using the Control Plane or the User Plane for small data delivery. For example, this may be based on the signaling load on the network interfaces (between the core network nodes, between RAN nodes, or between RAN and core network nodes) or the load on the RAN nodes and/or core network nodes. It should be understood that this is only an example of a typical trigger. A network may have other triggers to have a UE change the small data delivery method. For example, this may be based on the user plane congestion, observed traffic patterns of the UE, or some other condition observed or measured in the RAN nodes or core network nodes. In addition, this may also be based on preference from the Application Server. For example, a UE may be communicating to an AS through the user plane but would prefer to communicate through the control plane. Application Server may ask network to trigger the UE to change the small data delivery method.

Herein, the term “procedure” generally refers to techniques of performing operations to achieve particular ends. The term “procedure” is used in place of “method” to avoid confusion with special meanings of the term “method” in the context of M2M and IoT applications. The steps described for procedures are often optional, and potentially be performed in a variety of ways and a variety of sequences. Hence, herein the term “procedure” should not be interpreted as referring to a rigid set and sequence of steps, but rather to a general methodology for achieving results that may be adapted in a variety of ways.

Small data delivery may be used in a 4G (EPC) system. The SCEF, Control Plane Data Delivery, and Non-IP Data were introduced in Release 13. The stage-2 specifications for the SCEF, Control Plane Data Delivery, and Non-IP Data are in TS 23.682 Architecture enhancements to facilitate communications with packet data networks and applications, and TS 23.401 General Packet Radio Service (GPRS) enhancements for Evolved Universal Terrestrial Radio Access Network (E-UTRAN) access.

As of Rel-13, PDN Connections may terminate at the SCEF or the P-GW. Whether a PDN Connection terminates at the SCEF or the P-GW is determined by an “Invoke SCEF Selection” flag in the APN Configuration information in the UE's subscription. Only non-IP PDN connections may terminate at the SCEF and whether the PDN connection terminates at the SCEF or the P-GW is transparent to the UE.

In Release-13, 3GPP added the ability to send data over the control plane. Control Plane (CP) CIoT Optimizations refer to sending user data over the CP to the MME/SGSN in a NAS message, reducing the total number of CP messages required for Small Data Delivery.

When a PDN Connection is established, the network (MME) may signal to the UE that the PDN Connection is “Control Plane Only”. When this is signaled, the PDN connection is pinned to the control plane and the UE will never attempt to send data that is associated with this PDN connection over the user plane. TS 23.401 General Packet Radio Service (GPRS) enhancements for Evolved Universal Terrestrial Radio Access Network (E-UTRAN) Access states that “If the MME based on local policy determines the PDN connection shall only use the Control Plane CIoT EPS Optimisation, the MME shall include a Control Plane Only Indicator in the Session Management Request. For PDN connections with an SCEF, the MME shall always include the Control Plane Only Indicator. A UE receiving the Control Plane Only Indicator, for a PDN connection shall only use the Control Plane CIoT EPS optimisation for this PDN connection.”

Since, SCEF-terminated PDN connection cannot use the user-plane, it can be expected that the network will always set the PDN Connection's “Control Plane Only” indication if the “Invoke SCEF Selection” flag is set.

The control plane and user plane may be chosen in a number of ways. The UE may send data over the control plane by simply sending the data in an uplink NAS message. Assuming that the PDN Connection's “Control Plane Only” indication is not set, the UE may also decide to send data over the user plane. If the UE decides to put the PDN connection on the user plane, it sets the “active flag” when it makes a control plane service request. See section 5.3.4B.4 of TS 23.401.

The MME may decide to move the PDN connection to the user plane by rejecting the UE's control plane service request (see sections 4.3.7.4.2 and 5.3.4B.4 of TS 23.401).

The MME may decide to move a PDN Connection to the user plane because the control plane is congested or because of internal MME policies, for example a policy may dictate that the UE is sending too much data on the CP.

The UE may decide to move a PDN Connection to the user plane based on internal UE preference or policies.

In TR 23.724 Study on Cellular IoT support and evolution for the 5G System 3GPP WG SA2 is capturing the results of a study on IoT topics. One topic in the study is how to efficiently send small data packets in the 5GC.

Solution 1 in TR 23.724 describes how small data packets may be sent over the control plane (NAS). In Solution 1, the PDU Session may terminate at the UPF or the NEF.

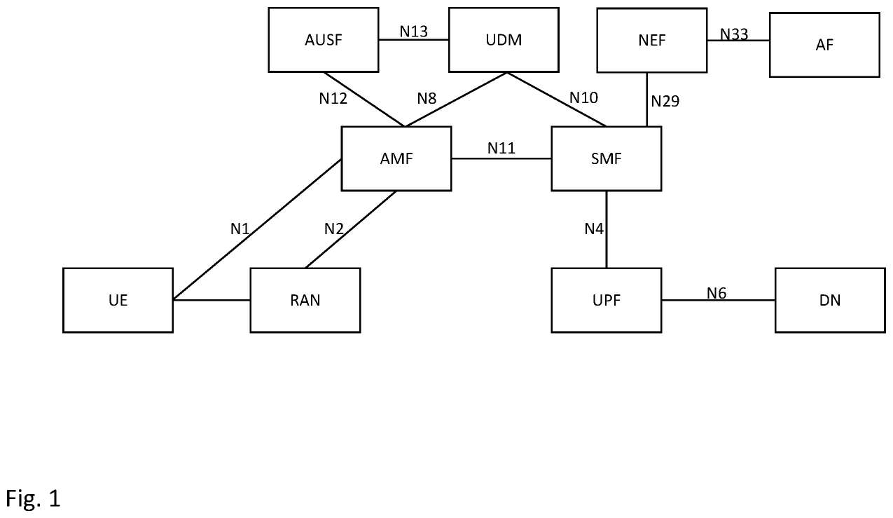

Similar to the 4G solution, the UE's subscription may include an “Invoke NEF Selection” flag for the DNN/S-NSSAI combination and that indication is used by the network to determine if the PDU session terminates at the UPF or NEF. FIG. 1 is copied from TR 23.724 and shows the main architecture diagram for the solution.

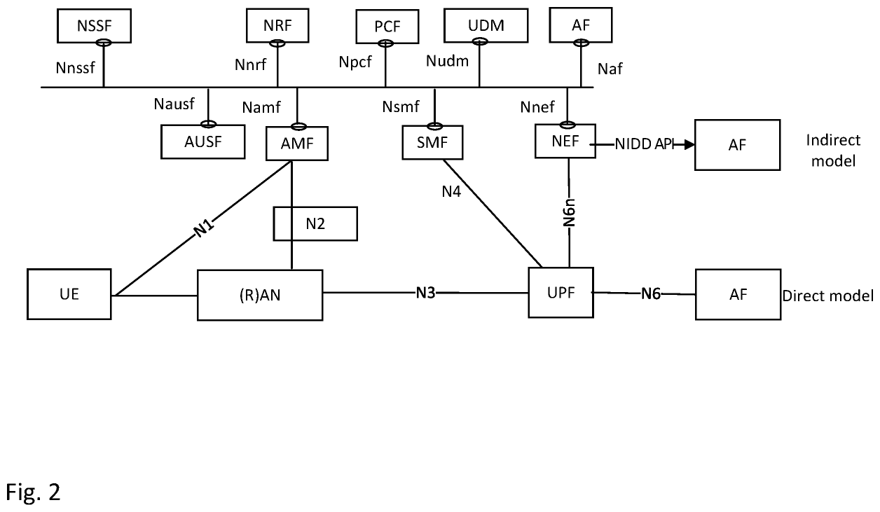

Solution 35 in TR 23.724 describes how small data packets may be sent over the user plane to a UPF and forwarded to the NEF by the UPF. FIG. 2 is copied from TR 23.724 and shows an example of the proposed architecture from solution 35. Notice the presence of the N6n interface between the UPF and NEF to support small data exchange between the NEF and UPF.

### Example Challenges

Whether a network operator prefers that a UE send data via the control plane or user plane may depend on factors such as the network topology (in terms of how much resources are dedicated to the control plane) and the current state of the network (in terms of congestion).

Whether a UE prefers to send data via the control plane or user plane may depend on the overhead associated with sending data (in terms of over the air signaling) compared to the amount of data that needs to be sent and the frequency with which it needs to be sent. For example, if the UE only needs to send 1 small data packet per 12 hours, it may prefer to send it via the control plane in order to reduce the amount of over the air signaling, thus increasing battery life.

In the 4G System, the network is not able to direct a PDN connection to the user plane until after the UE attempts to send data on the control plane. The network may desire to do this in scenarios where the control plane is congested, however this initial attempt by the UE to send data via the control plane is wasteful in terms of UE signaling and control plane congestion. Also, later, when the UE has more data to send, the UE may attempt to send data via the control plane again; thus, a ping-pong effect is created. Also, once the PDN connection has been established, the network is not able to direct the UE to stop using the user plane and begin using the control plane.

A similar problem exists in the 5GC; if we assume that the 5GC supports the ability to send data packets via the control plane in a manner that is similar to solution 1 in TR 23.724 and via the user plane in a manner that is similar to solution 35 in TR 23.724, then it would also be desirable to have a way to direct the UE when it should use the control plane and when it should use the user plane.

### Example Implementations

Several approaches that may be used to provision a UE with policies (or rules) that may be used by the UE to determine when to send data over the control plane and when to send it over the user plane. For example, policies may be provided to the UE at the application, or service layer. A 4G or 5G system, for example, may be enhanced to allow the UE to be provided with rules or policies that may be used by the UE to determine if the control plane or user plane should be used.

Control Plane and User Plane Selection via the Application/Service Layer

Given the maturity of 3GPP Rel-13 through 15, it might not be desirable to modify Releases 13 through 15 of the 3GPP specifications to provide the UE and Network with improved methods for steering PDN connections between the control and user planes.

A way to more efficiently steer traffic between the user and control planes is to provision an application, or service layer, that is hosted on the UE with policies, or rules, for how to determine if data should be sent over the control plane or user plane.

For example, an ANDSF or LWM2M client on the UE may receive CPUP Selection Policies. Other applications on the UE may view the policies and use this information to determine when to send data via the control plane or user plane.

In another example, a Service Layer that is hosted on the UE may be provisioned with CPUP Selection Policies. The Service Layer may use the policies to determine when to send data via the control plane or user plane. In a oneM2M embodiment, a <cseBase> resource that is associated with the service layer may be provisioned with a sub-resource or attribute that contains CPUP Selection policies. Alternatively, the <cseBase> resource may be provisioned with a sub-resource or attribute that is a link to the CPUP Selection policies. The service layer may then resolve the link to a network address and read the content of the policies.

Content of a Control Plane/User Plane Selection Policy

The CPUP policies may contain the information that is listed in Table 2 of the Appendix.

Although the policy in Table 2 of the Appendix shows information to select between control plane and user plane, it should be understood that this may be extended to provide other small data transmission options. For example, we may have policies for one or more of the following transmission options: control plane through the SCEF or NEF; control plane through a P-GW or UPF; user plane through a P-GW or UPF; or user plane through a SCEF or NEF.

One of these policies may be marked as a default policy. The UE should use this default policy if none of the conditions allow selection of a policy.

A broadcast approach may be used for control plane and user plane selection via enhancements to the 4G system. The MME may indicate to the eNodeB that the control plane is currently congested. The eNodeB may then broadcast a control plane congestion indication in a SIB. The UE may receive the SIB. If the SIB indicates that the control plane is congested, the UE may interpret it as an indication that all traffic should be sent over the user plane if the UE is capable of sending data over the user plane. The indication may be interpreted by UEs that all PDN connections should move to the user plane or that only new PDN connections should use the user plane or that PDN connections should move to the user plane at the next service request.

Alternatively, the eNodeB may determine that the control plane is congested and initiate broadcast of the indication in the SIB and indicate to the MME that the control plane is congested.

Alternatively, the eNodeB may broadcast, in the SIB, a policy or a value that may be mapped to a policy and used by the UE to determine when the control plane and when the user plane should be used.

A rate control approach may also be used. Per Section 4.7.7.3 of reference TS 23.401, the network provides the UE with APN Uplink Rate Control information when a PDN connection is established. This information is provided in the PCO information element. Per reference TS 23.401, “The APN Uplink Rate Control applies to data PDUs sent on that APN by either Data Radio Bearers (S1-U) or Signalling Radio Bearers (NAS Data PDUs).”

The network may instead provide two sets of APN Uplink Rate Control information when a PDN connection is established; one set for the user plane (Data Radio Bearers (S1-U)) and one set for the control plane (Signalling Radio Bearers (NAS Data PDUs)).

If the UE exceeds the control plane maximum number of packets per time unit, then the UE may move the PDN connection to the user plane.

The APN Uplink Rate Control information may be further enhanced to include a threshold rate that is used by the UE to determine if data should be sent over the control or user plane.

Any of the information from Table 2 of the Appendix may be included in the PCO.

A policy provisioning approach may also be used. A new management object may be defined, or an existing management object may be enhanced, to include the information from Table 2 of the Appendix. The contents of the management object may be provided to the UE via SMS or NAS messaging (or via IP based mechanisms such as ANDSF, LWM2M, and oneM2M). The contents of the management object may be stored in the Subscriber Identification Module (SIM). The content of the management object may be used by the UE to determine if data should be sent via the control plane or user plane.

The UE may behave in a manner such that provisioned policies always take precedence over policy information, such as APN Rate Control information, that is received in the PCO. Alternatively, the PCO information may take precedence when signaled. When the UE attaches, or establishes a PDN Connection, it may indicate that it is capable of receiving CPUP policies.

UE CP/UP settings may be provided to the network in a number of ways. The overall information used by the UE to determine its behavior in relationship to transitioning between User Plane and Control Plane is captured in rules referred to as “UE CP/UP Settings.” The UE CP/UP Settings may be determined using all or some of the methods outlined before, e.g., the UE may use a provisioned policy which is then merged with the policy information provided via broadcast. In addition, the UE user may input UE CP/UP settings via a GUI, or they may be derived from user settings, e.g., the Service Layer derives rules from the relative priorities of communications supported by different applications. In another scenario, an Application Server communicating with the Applications on the UE is used to provide input for the UE CP/UP settings.

The UE CP/UP settings may be used by the network to optimize its resources, and the UE may provide this information to the network. For example, the UE CP/UP Settings may be provided to the network by an Application Server along with Communication Patterns, or via a similar mechanism. The UE may also provide its UE CP/UP Settings directly to the network.

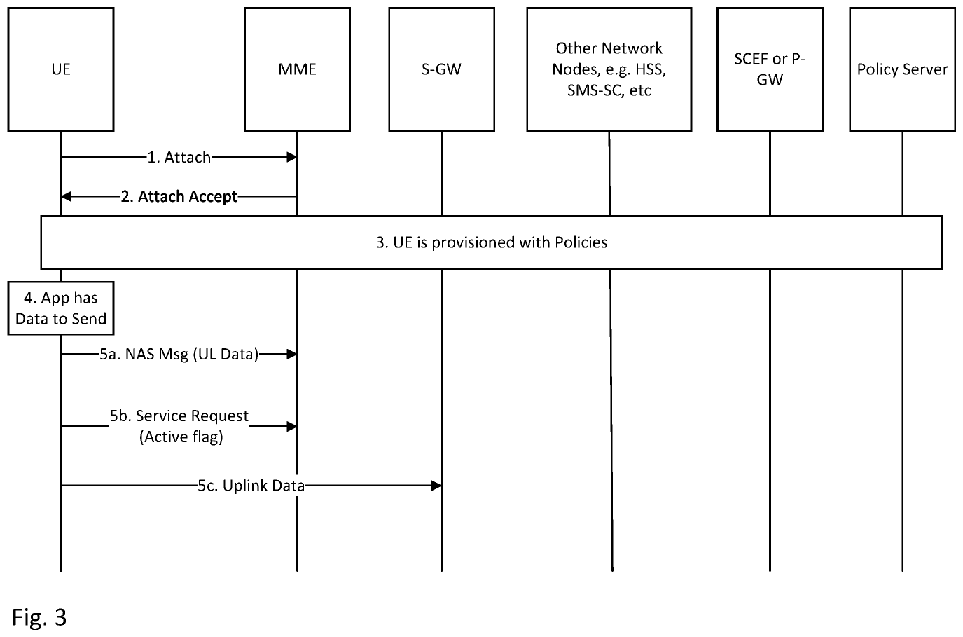

FIG. 3 shows an overall message flow and how the above enhancements fit into the 4G system.

In Step 1, the UE attaches to the network. The attach request message may indicate to the MME that it supports receiving CPUP policies.

In Step 2, the attached accept message from the MME indicates to the UE that the network supports provisioning the UE with CPUP policies.

In Step 3, the UE is provisioned with CPUP policies. The network may initiate sending the policies to the UE via an SMS (e.g., WAP Push) or NAS message. The UE may initiate the policy provisioning processes by contacting the Policy Server (e.g., contacting the ANDSF via the S14 interface or contacting the LWM2M Server). The UE may have been provisioned with an APN that is used to contact the Policy Server.

In Step 4, an application on the UE initiates UL data. The application, or a service layer that hosts the application, checks the provisioned policies (e.g., the polices that are described in Table 2 of the Appendix) and compares them against expected application behavior in terms of how much data the application expects to send and how often the application expects to send data. Based on that comparison, a decision is made to send the data over the control plane or user plane.

In Step 5a, if the control plane was selected, then the UE sends the UL data in a NAS message

In Step 5b, if the user plane was selected, the UE makes a Service Request and set the “Active Flag” to indicate that the user plane will be used.

In Step 5c, if the user plane was selected, the UE sends data via the user plane.

In Step 6, optionally, the UE CP/UP Settings are provided to the network for resource optimization

A broadcast approach may be used for control plane and user plane selection via enhancements to a 5G system.

Similar to the 4G approach that is described above, the AMF may indicate to a RAN node that the control plane is currently congested. The RAN node may then broadcast a control plane congestion indication in a SIB. The UE may receive the SIB. If the SIB indicates that the control plane is congested, the UE may interpret it as an indication that all traffic should be sent over the user plane if the UE is capable of sending data over the user plane. The indication may be interpreted by UEs that all PDU sessions should move to the user plane or that only new PDU sessions should use the user plane or that PDU sessions should move to the user plane at the next service request.

In a 5G system, a UE may connect to the network via an N3IWF. In this scenario, the AMF may notify UE(s), via a NAS notification, that the control plane is congested.

A rate control approach may be used for control plane and user plane selection via enhancements to a 5G system.

Similar to the 4G approach that is described above, the NEF or UPF may provide the UE with APN rate control policies that may be used by the UE to help the UE to determine if data should be sent over the control plane or the user plane.

Any of the information from Table 2 of the Appendix may be included in the PCO when a 5G PDU Session is established.

A policy provisioning approach may be used for control plane and user plane selection via enhancements to a 5G system.

Similar to the 4G approach that is described above, a new management object or policy may be defined, or an existing management object or policy may be enhanced, to include the information from Table 2 of the Appendix. The contents of the management object may be provided to the UE via SMS or NAS messaging (or via IP based mechanisms such as ANDSF, LWM2M, and oneM2M). The contents of the management object may be stored in the Subscriber Identification Module (SIM). The content of the management object may be provided by the PCF to the UE, via NAS messaging and may be used by the UE to determine if data should be sent via the control plane or user plane.

The UE may behave in a manner such that provisioned policies always take precedence over policy information, such as APN Rate Control information, that is received in the PCO. Alternatively, the PCO information may take precedence when signaled. When the UE registers, or establishes a PDU Session, it may indicate that it is capable of receiving CPUP policies.

In the scenario where there is a Network triggered PDU Session Establishment procedure, network sends the device trigger message to application(s) on the UE side. The payload included in Device Trigger Request message contains information on which application on the UE side is expected to trigger the PDU Session establishment request. Based on that information, the application(s) on the UE side trigger the PDU Session Establishment procedure. The payload may be further enhanced to carry any of the information from Table 2 of the Appendix in order to indicate to the UE if the PDU Session should be established over the user plane or control plane. When the UE registers, or establishes a PDU session, it may indicate that it is capable of receiving CPUP policies.

UE CP/UP settings may be provided to the network in a number of ways. Similar to the 4G approach that is described above, the UE CP/UP Setting may be provided to the network for resource optimization purposes. For example, the CP/UP Settings may be provided in conjunction with the UE Communication Patterns or via a similar mechanism. The Network uses this information to anticipate resource use, for example, in addition to planning for the UE communicating during the times indicated, it may also plan how to divide resources between UP and CP. In addition, the network is able to predict how UEs will behave in response to its indications (e.g., broadcast approach) given the overall UE CP/UP Settings.

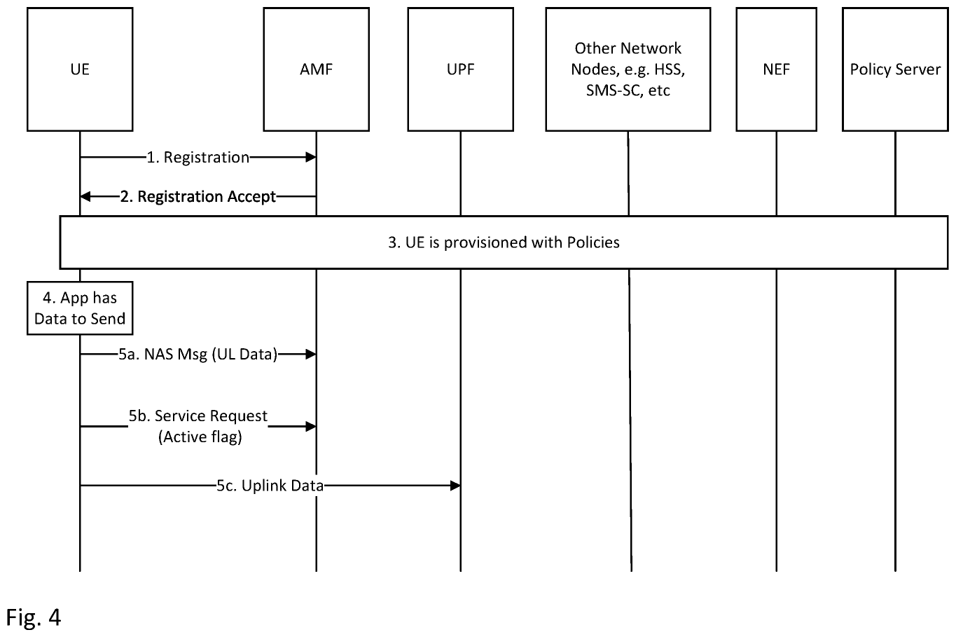

FIG. 4 shows an overall message flow and how the above enhancements fit into the 5G system.

In Step 1, the UE registers with the network. The registration request message may indicate to the AMF that it supports receiving CPUP policies. This indication may also be included in a registration update, service request, UE configuration update, or session establishment procedure.

In Step 2, the registration accept message from the AMF indicates to the UE that the network supports provisioning the UE with CPUP policies.

In Step 3, the UE is provisioned with CPUP policies. The network may initiate sending the policies to the UE via an SMS (e.g., WAP Push) or via the PCF via the NAS message. The UE may initiate the policy provisioning processes by contacting the Policy Server (e.g., contacting the ANDSF via the S14 interface or contacting the LWM2M Server). The UE may have been provisioned with a DNN and S-NSSAI that is used to contact the Policy Server.

In Step 4, an application on the UE initiates UL data. The application, or a service layer that hosts the application, checks the provisioned policies (e.g., the polices that are described in Table 2 of the Appendix) and compares them against expected application behavior in terms of how much data the application expects to send and how often the application expects to send data. Based on that comparison, a decision is made to send the data over the control plane or user plane.

In Step 5a, if the control plane was selected, then the UE sends the UL data in a NAS message.

In Step 5b, if the user plane was selected, the UE makes a Service Request and set the “Active Flag” to indicate that the user plane will be used.

In Step 5c, if the user plane was selected, the UE sends data via the user plane.

In Step 6, optionally, the UE CP/UP Settings are provided to the network for resource optimization

### Example Frameworks

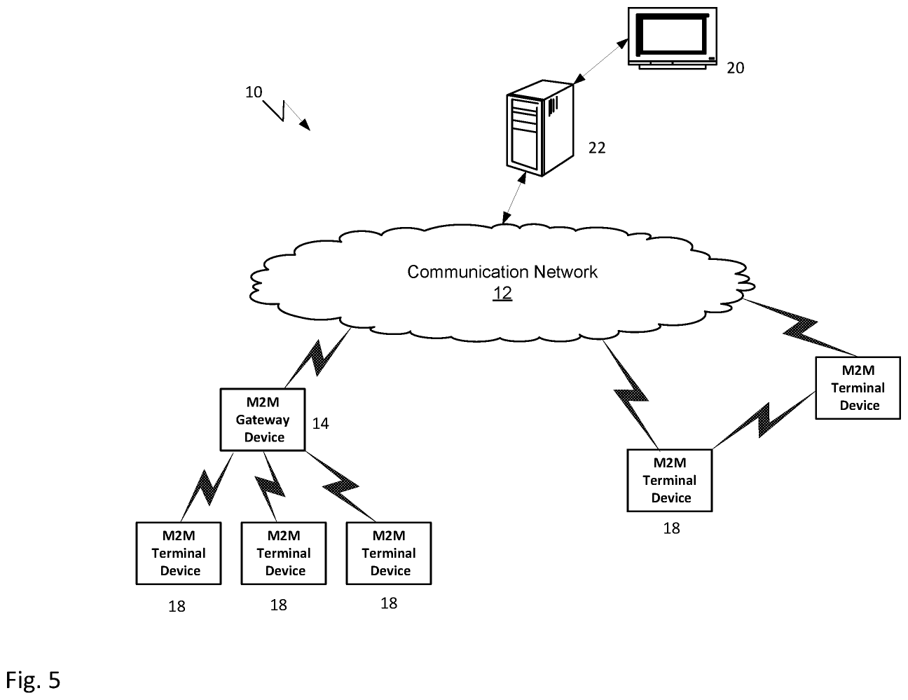

FIG. 5 is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway, M2M server, or M2M service platform may be a component or node of the IoT/WoT as well as an IoT/WoT Service Layer, etc. Any of the client, proxy, or server devices illustrated in FIG. 3 or 4 may comprise a node of a communication system, such as the ones illustrated in FIG. 3 or 4.

The service layer may be a functional layer within a network service architecture. Service layers are typically situated above the application protocol layer such as HTTP, CoAP, or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above-mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures, and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

As shown in FIG. 5, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 5, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link. A M2M gateway 14 allows wireless M2M devices (e.g., cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M Service Layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

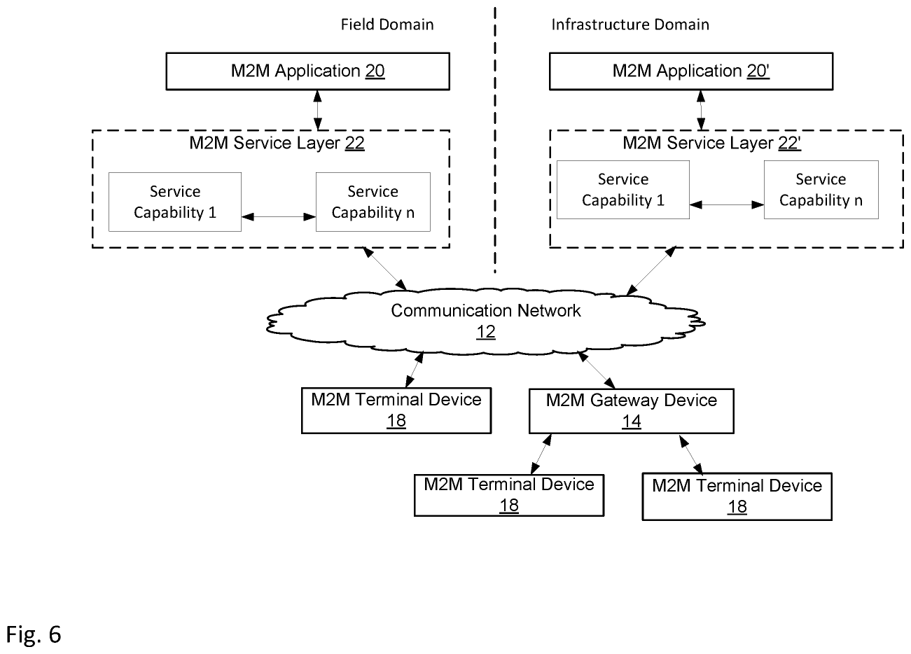

Referring to FIG. 6, the illustrated M2M Service Layer 22 in the field domain provides services for the M2M application 20, M2M gateways 14, and M2M devices 18 and the communication network 12. It will be understood that the M2M Service Layer 22 may communicate with any number of M2M applications, M2M gateways 14, M2M devices 18, and communication networks 12 as desired. The M2M Service Layer 22 may be implemented by one or more nodes of the network, which may comprise servers, computers, devices, or the like. The M2M Service Layer 22 provides service capabilities that apply to M2M devices 18, M2M gateways 14, and M2M applications 20. The functions of the M2M Service Layer 22 may be implemented in a variety of ways, for example as a web server, in the cellular core network, in the cloud, etc.

Similar to the illustrated M2M Service Layer 22, there is the M2M Service Layer 22′ in the Infrastructure Domain. M2M Service Layer 22′ provides services for the M2M application 20′ and the underlying communication network 12 in the infrastructure domain. M2M Service Layer 22′ also provides services for the M2M gateways 14 and M2M devices 18 in the field domain. It will be understood that the M2M Service Layer 22′ may communicate with any number of M2M applications, M2M gateways, and M2M devices. The M2M Service Layer 22′ may interact with a Service Layer by a different service provider. The M2M Service Layer 22′ may be implemented by one or more nodes of the network, which may comprise servers, computers, devices, virtual machines (e.g., cloud computing/storage farms, etc.) or the like.

Referring also to FIG. 6, the M2M Service Layers 22 and 22′ provide a core set of service delivery capabilities that diverse applications and verticals may leverage. These service capabilities enable M2M applications 20 and 20′ to interact with devices and perform functions such as data collection, data analysis, device management, security, billing, service/device discovery, etc. Essentially, these service capabilities free the applications of the burden of implementing these functionalities, thus simplifying application development and reducing cost and time to market. The Service Layers 22 and 22′ also enable M2M applications 20 and 20′ to communicate through various networks such as network 12 in connection with the services that the Service Layers 22 and 22′ provide.

The M2M applications 20 and 20′ may include applications in various industries such as, without limitation, transportation, health and wellness, connected home, energy management, asset tracking, and security and surveillance. As mentioned above, the M2M Service Layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

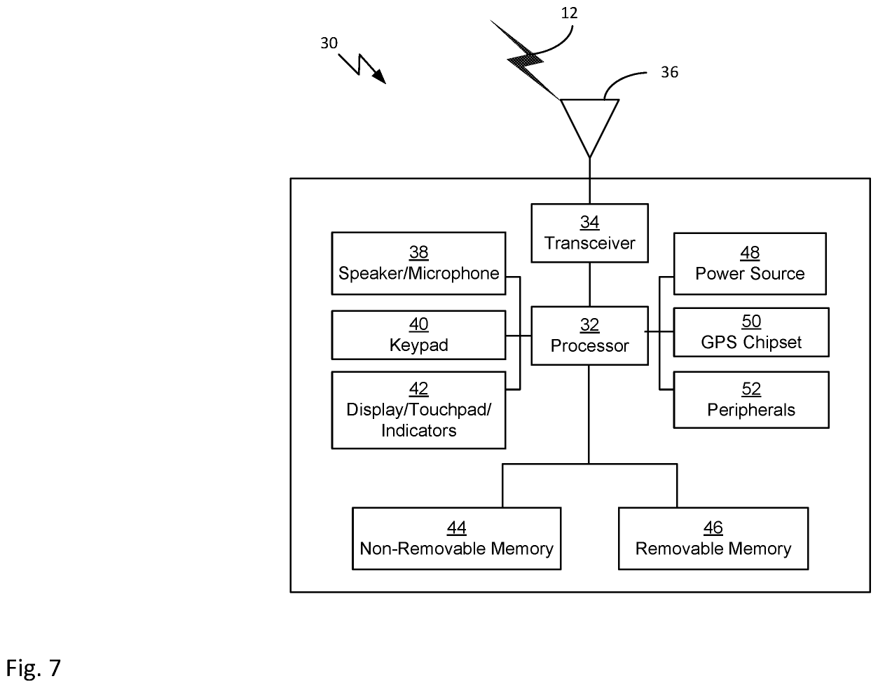

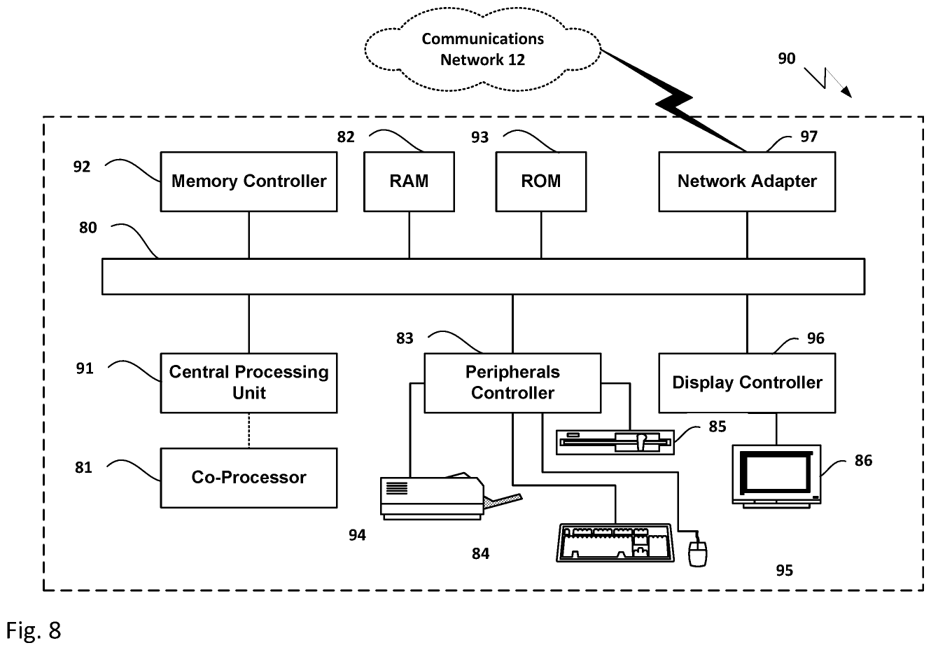

Generally, a Service Layer, such as the Service Layers 22 and 22′ illustrated in FIG. 6, defines a software middleware layer that supports value-added service capabilities through a set of Application Programming Interfaces (APIs) and underlying networking interfaces. Both the ETSI M2M and oneM2M architectures define a Service Layer. ETSI M2M's Service Layer is referred to as the Service Capability Layer (SCL). The SCL may be implemented in a variety of different nodes of the ETSI M2M architecture. For example, an instance of the Service Layer may be implemented within an M2M device (where it is referred to as a device SCL (DSCL)), a gateway (where it is referred to as a gateway SCL (GSCL)), and/or a network node (where it is referred to as a network SCL (NSCL)). The oneM2M Service Layer supports a set of Common Service Functions (CSFs) (i.e., service capabilities). An instantiation of a set of one or more particular types of CSFs is referred to as a Common Services Entity (CSE) which may be hosted on different types of network nodes (e.g., infrastructure node, middle node, application-specific node). The Third Generation Partnership Project (3GPP) has also defined an architecture for machine-type communications (MTC). In that architecture, the Service Layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the Service Layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a Service Layer or component thereof may be implemented in the form of software running on a network node (e.g., server, computer, gateway, device or the like) having the general architecture illustrated in FIG. 7 or FIG. 8 described below.

Further, the methods and functionalities described herein may be implemented as part of an M2M network that uses a Service Oriented Architecture (SOA) and/or a Resource-Oriented Architecture (ROA) to access services.

FIG. 7 is a block diagram of an example hardware/software architecture of a node of a network, such as one of the clients, servers, or proxies illustrated in FIG. 3 or 4, which may operate as an M2M server, gateway, device, or other node in an M2M network such as that illustrated in and of FIGS. 1 to 4. As shown in FIG. 7, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements control plane/user plane selection techniques, e.g., in relation to the methods described in reference to FIG. 3 or 4, Table 2, or in a claim.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 7, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the control plane/user plane selection techniques herein, e.g., in relation to FIG. 3 or FIG. 4, or in a claim. While FIG. 7 depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 7 as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality, and/or wired or wireless connectivity. For example, the peripherals 52 may include various sensors such as an accelerometer, biometrics (e.g., finger print) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 8 is a block diagram of an exemplary computing system 90 which may also be used to implement one or more nodes of a network, such as the clients, servers, or proxies illustrated in FIG. 3 or 4, which may operate as an M2M server, gateway, device, or other node in an M2M network such as that illustrated in and of FIGS. 1 to 4

Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, which performs additional functions or assists CPU 91. CPU 91 and/or coprocessor 81 may receive, generate, and process data related to the disclosed systems and methods for E2E M2M Service Layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97, that may be used to connect computing system 90 to an external communications network, such as network 12 of FIGS. 5-8, to enable the computing system 90 to communicate with other nodes of the network.

### APPENDIX

TABLE 1
Acronyms

| | |
|---|---|
| AF | Application Function |
| AMF | Access Management Function |
| ANDSF | Access Network Discovery and Selection Function |
| APN | Access Point Name |
| AUSF | Authentication Server Function |
| CIoT | Cellular IoT |
| CP | Control Plane |
| CSE | Common Services Entity |
| DN | Data Network |
| DNN | Data Network Name |
| EPC | Evolved Packet Core |
| EPS | Evolved Packet System |
| GPRS | General Packet Radio Service |
| GPS | Global Positioning System |
| IoT | Internet of Things |
| IP | Internet Protocol |
| LWM2M | Light Weight Machine-to-Machine |
| MME | Mobility Management Entity |
| MO | Management Object |
| N3IWF | Non-3GPP Interworking Function |
| NAS | Non-Access Stratum |
| NEF | Network Exposure Function |
| NRF | Network Repository Function |
| NSSF | Network Slice Selection Function |
| PCF | Policy Control Function |
| PCO | Protocol Configuration Options |
| PDN | Packet Data Network |
| PDUPDUDR | Packet Data Unit Detection Rule |
| P-GW | PDN Gateway |
| PLMN | Public Land Mobile Network |
| RAN | Radio Access Network |
| RAT | Radio Access Technology |
| SCEF | Service Capability Exposure Functions |
| SGSN | Serving GPRS Support Node |
| SIB | System Information Block |
| SIM | Subscriber Identification Module |
| SMF | Session Management Function |
| SMS | Short Message Service |
| S-NSSAI | Single Network Slice Selection Identifier |
| TA | Tracking Area |
| UDM | User Data Management |
| UE | User Equipment |
| UP | User Plane |
| UPF | User Plane Function |

TABLE 2
CPUP Policy

| Field | Usage |
|---|---|
| Maximum Control Plane | If the UE has to send data that is greater than this size, then the user plane should be used. |
| Packet Size | |
| Minimum User Plane Packet | If the UE has to send data that is less than this size, then the control plane should be used. |
| Size | |
| Control Plane Maximum Rate | A positive integer number of packets per time unit. For example, if the control plane rate |
| | exceeds this maximum, then the user plane should be used. |
| Control Plane Exception | An indication as to whether or not exception reports can still be sent if this rate control limit |
| Reports Permitted | has been met. |
| Control Plane Allowed | An integer ‘number of additional allowed exception reports per time unit' once the rate control |
| Number of Exception Reports | limit has been reached. |
| User Plane Maximum Rate | A positive integer number of packets per time unit. For example, if the user plane rate |
| | exceeds this maximum, then the control plane should be used. |
| User Plane Exception Reports | An indication as to whether or not exception reports can still be sent if this rate control limit |
| Permitted | has been met. |
| User Plane Allowed Number | An integer ‘number of additional allowed exception reports per time unit' once the rate control |
| of Exception Reports | limit has been reached. |
| APN/DDN | The APN (4G), or DNN (5G), where the policy applies. |
| S-NSSAI | The slice where the policy applies (5G only) |
| RAT(s) | The RAT(s) where the policy applies |
| PLMN ID | The PLMN where the policy applies |
| Location | The locations (GPS, TA, etc.) where the policy applies. |
| Session Type | The session type (IP, Ethernet, unstructured, etc.) that the policy applies to. |
| CPUP Schedule | A schedule defining time windows for when a UE should use UP and CP |
| CPUP Application Type | Rules defining which types of traffic are permitted to use the UP or CP. For example, this |
| Rules | could be based on type of application generating the traffic. The rules may be formatted like |
| | a PDR. |
| User Specific Rules | An indication of whether certain users, or user types, are permitted, or restricted from, |
| | sending data via the control plane. |
| Maximum Control Load | If network broadcasts a load level greater than this maximum, then the user plane should be |
| Level | used |
| Minimum Control Load Level | If network broadcasts a load level lower than this minimum, then the control plane should be |
| | used |

1. A user equipment apparatus (UE), comprising a processor, a memory, and communication circuitry, the UE being connected to a network via the communication circuitry, the UE further comprising computer-executable instructions stored in the memory which, when executed by the processor, cause the UE to:
receive a message comprising a control plane/user plane (CPUP) policy, the CPUP policy comprising one or more criteria for determining whether data should be sent by the UE via a control plane or a user plane;
make a determination, based at least in part on the CPUP policy, whether to send data via the control plane or the user plane; and
send data in accordance with the determination.

2. The UE of claim 1, wherein the message is received via Non-Access Stratum (NAS) signaling from a Policy Control Function (PCF).

3. The UE of claim 1, wherein the instructions further cause the UE to send, to a policy server, a request, the request being for the CPUP policy.

4. The UE of claim 3, wherein the instructions further cause the UE to send the request to a Policy Control Function (PCF) via non-access stratum (NAS) signaling.

5. The UE of claim 3, wherein the instructions further cause the UE to:
form a connection by using a Data Network Name (DNN) and a Single Network Slice Selection Assistance Identifier (S-NSSAI), the S-NSSAI being provisioned on the UE for the purpose of contacting to the policy server; and
send the request using the connection.

6. The UE of claim 1, wherein the one or more criteria comprise a CPUP application type rule.

7. The UE of claim 4, wherein the one or more criteria further comprise one or more of: a maximum control plane packet size; a minimum user plane packet size; a control plane maximum rate; and a user plane maximum rate.

8. The UE of claim 4, wherein the one or more criteria further comprise one or more of a Public Land Mobile Network identifier (PLMN ID) and a session type.

9. The UE of claim 1, wherein the instructions further cause the UE to store the CPUP policy in a Management Object (MO).

10. The UE of claim 8, wherein the instructions further cause the UE to store the MO in a Subscriber Identification Module (SIM).

11. The UE of claim 1, wherein:
the determination is to send data via the user plane; and
the instructions further cause the UE to send a service request message, the service request message comprising an active flag that is set.

12. The UE claim 1, wherein:
the determination is to send data via the control plane; and
the instructions further cause the UE to send data in accordance with the determination via Non-Access Stratum (NAS) signaling.

13. A policy server, comprising a processor, a memory, and communication circuitry, the policy server being connected to a network via the communication circuitry, the policy server further comprising computer-executable instructions stored in the memory which, when executed by the processor, cause the policy server to:
send, to a user equipment apparatus (UE), a message comprising a control plane/user plane (CPUP) policy, the CPUP policy comprising one or more criteria for determining whether data should be sent by the UE via a control plane or a user plane.

14. The policy server of claim 13, wherein the instructions further cause the policy server to receive, from the UE, a request for the CPUP policy.

15. The policy server of claim 13, wherein the policy server is a Policy Control Function (PCF) and the message is sent via Non-Access Stratum (NAS) signaling.

16. The policy server of claim 15, wherein the instructions further cause the policy server to receive, from the UE via NAS signaling, a request for the CPUP policy.

17. The policy server of claim 13, wherein the one or more criteria comprise a CPUP application type rule.

18. The policy server of claim 17, wherein the one or more criteria further comprise one or more of: a maximum control plane packet size; a minimum user plane packet size; a control plane maximum rate; and a user plane maximum rate.

19. The policy server of claim 17, wherein the one or more criteria further comprise one or more of a Public Land Mobile Network identifier (PLMN ID) and a session type.

20. The policy server of claim 13, wherein the message is sent via Short Message Service (SMS).
